(19) United States
(12) Patent Application Publication
(10) Pub. No.: US 2024/0135905 A1
(43) Pub. Date: Apr. 25, 2024

(54) AUDIO MIXING SONG GENERATION METHOD AND APPARATUS, DEVICE, AND STORAGE MEDIUM

(71) Applicant: Tencent Music Entertainment Technology (Shenzhen) Co., Ltd., Shenzhen (CN)

(72) Inventor: Zhenhai Yan, Shenzhen (CN)

(73) Assignee: Tencent Music Entertainment Technology (Shenzhen) Co., Ltd., Shenzhen (CN)

(21) Appl. No.: 18/278,602

(22) PCT Filed: Oct. 7, 2021
(86) PCT No.: PCT/CN2021/122573

§ 371 Date: Aug. 22, 2023

(30) Foreign Application Priority Data
Feb. 24, 2021 (CN) 202110205483.9

(51) Int. Cl. G10H 1/00

(52) U.S. Cl. CPC G10H 1/0025; G10H 2210/076; G10H 2210/125; G10H 2210/131

(57) ABSTRACT

A method and an apparatus for generating a remix. The method comprises: obtaining at least two audios which are different singing versions of a same song: extracting, from each audio, a vocal signal and an instrumental signal to obtain a vocal set the vocal signal of each audio and a instrumental set comprising the instrumental signal of each audio: aligning tracks of all vocal signals in the vocal set based on reference rhythm information selected from rhythm information of all vocal signals in the vocal set, where all vocal signals having the aligned tracks serve as to-be-mixed vocal audios: determining an instrumental signal, of which a track is aligned with those of the to-be-mixed vocal audios, from the instrumental set as a to-be-mixed instrumental audio: and mixing the to-be-mixed vocal audios with the to-be-mixed instrumental audio to obtain the remix.

This application claims priority to Chinese Patent Application No. 202110205483.9, titled “METHOD AND APPARATUS FOR GENERATING REMIX, DEVICE, AND STORAGE MEDIUM”, filed on Feb. 24, 2021 with the China National Intellectual Property Administration, which is incorporated herein by reference in its entirety.

### FIELD

The present disclosure relates to the technical field of computer signal processing, and in particular to a method and an apparatus for generating a remix, a device, and a storage medium.

### BACKGROUND

In conventional technology, a remix is made through mixing a left channel of a song with a right channel of another song, which creates a stereo effect. Generally, the two songs are different versions of a same song.

Due to reliance on manual production, the above mixing is applicable to only a limited number rather than a variety of songs. The simple mixing of left and right channels cannot guarantee coordination and synchronization in elements such as lyrics and beats, which may result in a poor mixing effect.

### SUMMARY

In view of the above, an objective of the present disclosure is providing a method and an apparatus for generating a remix, a device, and a storage medium. Remixes having a good mixing effect can be generated from a variety of songs. The technical solutions are as follows.

In a first aspect, a method for generating a remix is provided according to an embedment of the present disclosure. The method comprises: obtaining at least two audios which are different singing versions of a same song; extracting, from each of the at least two audios, a vocal signal and an instrumental signal to obtain a vocal set and an instrumental set, where the vocal set comprises the vocal signal of each of the at least two audios, and the instrumental set comprises the instrumental signal of each of the at least two audios; aligning tracks of all vocal signals in the vocal set through referring to reference rhythm information, where the reference rhythm information is selected from rhythm information of all vocal signals in the vocal set, and all vocal signals having the aligned tracks serve as to-be-mixed vocal audios; determining an instrumental signal, of which a track is aligned with the tracks of the to-be-mixed vocal audios, from the instrumental set as a to-be-mixed instrumental audio; and mixing the to-be-mixed vocal audios with the to-be-mixed instrumental audio to obtain the remix.

In a second aspect, an apparatus for generating a remix is provided according to an embodiment of the present disclosure. The apparatus comprises: an obtaining module, configured to obtain at least two audios which are different singing versions of a same song; an extracting module, configured to extract, from each of the at least two audios, a vocal signal and an instrumental signal to obtain a vocal set and an instrumental set, where the vocal set comprises the vocal signal of each of the at least two audios, and the instrumental set comprises the instrumental signal of each of the at least two audios; an aligning module, configured to align tracks of all vocal signals in the vocal set through referring to reference rhythm information, where the reference rhythm information is selected from rhythm information of all vocal signals in the vocal set, and all vocal signals having the aligned tracks serve as to-be-mixed vocal audios; a selecting module, configured to determine an instrumental signal, of which a track is aligned with the tracks of the to-be-mixed vocal audios, from the instrumental set as a to-be-mixed instrumental audio; and a mixing module, configured to mix the to-be-mixed vocal audios with the to-be-mixed instrumental audio to obtain the remix.

In a third aspect, an electronic device is provided according to an embodiment of the present disclosure. The electronic device comprises a processor and a memory. The memory stores a computer program, and the computer program when loaded and executed by the processor implements the foregoing method.

In a fourth aspect, a storage medium is provided according to an embodiment of the present disclosure. The storage medium stores computer-executable instructions, and the computer-executable instructions when loaded and executed by a processor implement the implement the foregoing method.

According to embodiments of the present disclosure, the at least two audios which are different singing versions of the same song are obtained, and then the vocal signal and the instrumental signal are extracted from each audio. Afterwards, the tracks of all vocal signals are aligned based on the reference rhythm information which is selected from the rhythm information corresponding to all audios, and the vocal signals having the aligned tracks serve as the to-be-mixed vocal audios. The instrumental signal of which the track is aligned with the tracks of the to-be-mixed vocal audios serves as the to-be-mixed instrumental audio. The to-be-mixed vocal audio and the to-be-mixed instrumental audio are mixed to obtain the remix. Herein the at least two singing versions of the same song can be mixed, and the mixing is applicable to a variety of songs. During the mixing, the tracks of all vocal signals in the singing versions are aligned, and the instrumental signal aligned with the to-be-mixed vocal signals in tracks is selected. Therefore, coordination and synchronization in elements such as lyrics and beats can be achieved when mixing vocal and instrumental, and thereby the obtained remix has an improved mixing effect.

Correspondingly, the apparatus, the device, and the storage medium according to embodiments of the present disclosure also have the foregoing technical effects.

### BRIEF DESCRIPTION OF THE DRAWINGS

For clearer illustration of the technical solutions according to embodiments of the present disclosure or conventional techniques, hereinafter briefly described are the drawings to be applied in embodiments of the present disclosure or conventional techniques.

Apparently, the drawings in the following descriptions are only some embodiments of the present disclosure, and other drawings may be obtained by those skilled in the art based on the provided drawings without creative efforts.

FIG. 1 is a schematic diagram of physical architecture applicable to an embodiment of the present disclosure.

FIG. 2 is a flowchart of a method for generating a remix according to an embodiment of the present disclosure.

FIG. 3 is a flowchart of a process of alignment according to an embodiment of the present disclosure.

FIG. 4 is a schematic diagram of beats according to an embodiment of the present disclosure.

FIG. 5 is a schematic diagram of data segments corresponding to a group of adjacent beats according to an embodiment of the present disclosure.

FIG. 6 is a schematic diagram of data segments corresponding to a group of adjacent beats according to another embodiment of the present disclosure.

FIG. 7 is a flowchart of a process of alignment according to another embodiment of the present disclosure.

FIG. 8 is a flowchart of a process for producing a remix according to an embodiment of the present disclosure.

FIG. 9 is a schematic diagram of an apparatus for generating a remix according to an embodiment of the present disclosure.

FIG. 10 is structural diagram of a server according to an embodiment of the present disclosure.

FIG. 11 is a structural diagram of a terminal according to an embodiment of the present disclosure.

### DETAILED DESCRIPTION

Conventional methods for making remixes rely on manual production, and hence are applicable to only a limited number rather than a variety of songs. The simple mixing of left and right channels cannot guarantee coordination and synchronization in elements such as lyrics and beats, which may result in a poor mixing effect.

In view of the above issues, a solution for generating a remix is proposed herein. The solution is applicable to more songs for audio mixing. During the mixing, tracks of all vocal signals in singing versions are aligned, and an instrumental signal aligned with the vocal signals in tracks is selected. Therefore, coordination and synchronization in elements such as lyrics and beats can be achieved when mixing vocal and instrumental audios, and thereby the obtained remix has an improved mixing effect.

Hereinafter physical architecture applicable to an embodiment of the present disclosure is introduced first to facilitate understanding.

A method for generating a remix according to an embodiment the present disclosure is applicable to a system or a program having a function of audio mixing, for example, a music game. The system or the program may run on a server, a personal computer, or other devices.

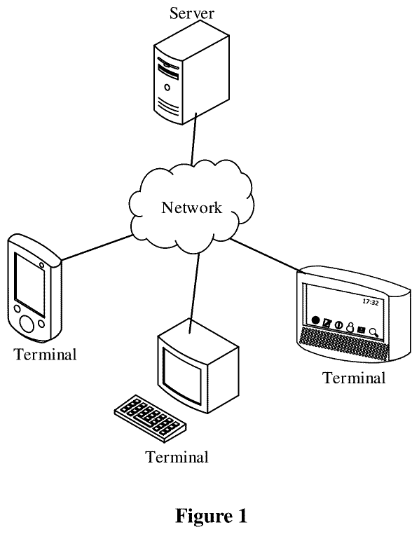

Reference is made to FIG. 1, which is a schematic diagram of physical architecture applicable to an embodiment of the present disclosure. A system or program having a function of audio mixing may run on a server as shown in FIG. 1. The server is configured to perform following operations. At least two audios which are different singing versions of a same song are obtained from a terminal device over a network. A vocal signal and an instrumental signal are extracted from each audio to obtain a vocal set and an instrumental set, where the vocal set comprises the vocal signal of each audio, and the instrumental set comprises the instrumental signal of each audio. Tracks of all vocal signals in the vocal set are aligned through referring to reference rhythm information, where the reference rhythm information is selected from rhythm information of all vocal signals in the vocal set, and all vocal signals having the aligned tracks serve as to-be-mixed vocal audios. An instrumental signal, of which a track is aligned with the tracks of the to-be-mixed vocal audios, is determined from the instrumental set as a to-be-mixed instrumental audio. The to-be-mixed vocal audios are mixed with the to-be-mixed instrumental audio to obtain the remix.

As shown in FIG. 1, the server may establish communication connections with multiple devices, and the server obtains audios from these devices for the mixing. The audios may be stored in a database. The server collects the audios, which are songs, uploaded by these devices and mixes the audios to obtain the remix. FIG. 1 shows various terminal devices, and in an actual scenario, there may be terminal devices of more or fewer types participating in the audio mixing. Specific quantity and types of the terminal devices depend on the actual scenario and are not limited herein. Although FIG. 1 shows a single server, multiple servers may participate in an actual scenario, and a specific quantity of the servers depends on the actual scenario.

Herein the method for generating the remix may be performed offline. That is, the server stores the audios locally, and is capable to execute the method according to an embodiment of the present disclosure directly so as obtain the desired remix.

The system or the program having the function of audio mixing may alternatively run on a personal mobile terminal or serve as a cloud service program. A specific operation mode depends on an actual scenario and is not limited herein.

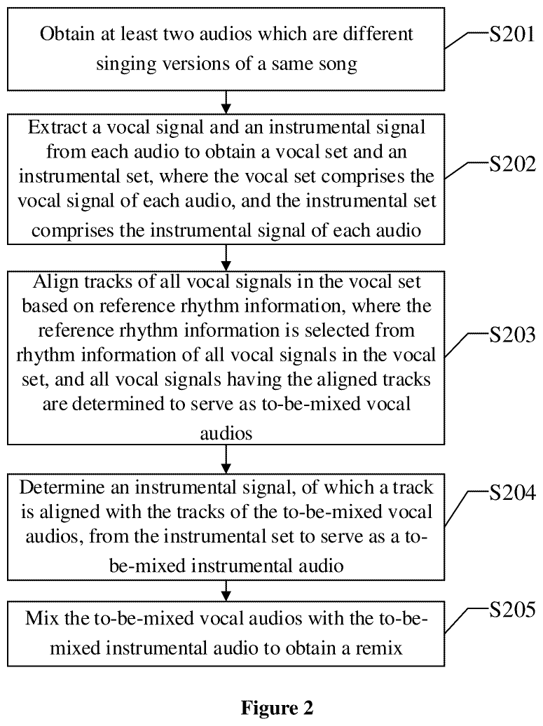

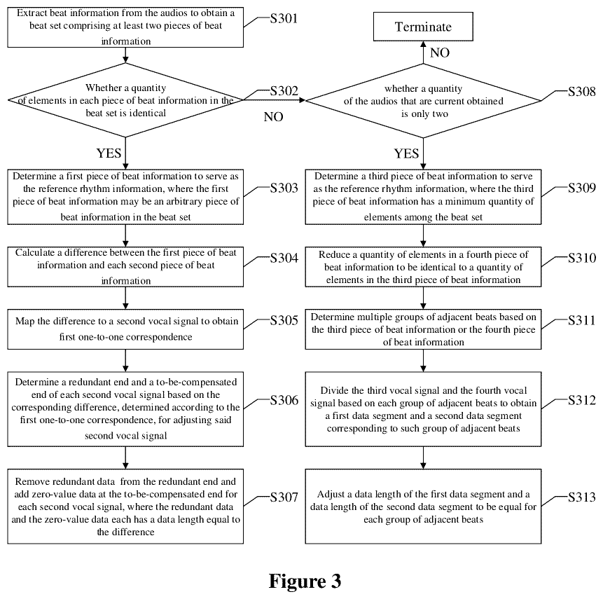

On a basis of the above, reference is made to FIG. 2, which is a flowchart of a method for generating a remix according to an embodiment of the present disclosure. As shown in FIG. 2, the method may comprise following steps S201 to S205.

In S201, at least two audios which are different singing versions of a same song are obtained.

For example, the different singing versions of the same song may include, for example, an original version, a cover version, and a remix version. Each audio may be in a format of, for example, MP3.

In S202, a vocal signal and an instrumental signal are extracted from each audio to obtain a vocal set and an instrumental set, where the vocal set comprises the vocal signal of each audio, and the instrumental set comprises the instrumental signal of each audio.

The vocal signal may be extracted from the audio through either of following manners.

In a first manner, a median signal corresponding to the audio is calculated, and the vocal signal is extracted from the median signal. Assuming that the audio (comprising both vocal and instrumental) has a left channel, i.e, dataLeft, and a right channel, i.e., dataRight, the median signal of the audio is calculated as

dataMid=(dataLeft+dataRight)/2.

Since the median signal can represent content of the audio better, extracting the vocal signal from the median signal can have a better vocal effect.

In a second manner, vocals are extracted from the left channel and the right channel, respectively, of each audio, and the left-channel vocal and the right-channel vocal are averaged in amplitude or spectral features to obtain the vocal signal in such audio. Assuming that the audio has the left-channel vocal (comprising vocal only), i.e., vocalLeft, and a right-channel vocal (comprising vocal only), i.e., vocalRight, the averaged vocal of the audio is calculated as (vocalLeft+vocalRight)/2. The averaged amplitude corresponds to a time domain, and the average spectral features correspond to a frequency domain. That is, the left-channel vocal and the right-channel vocal can be processed in two dimensions, i.e., time and frequency.

The instrumental signal may be gleaned from the left channel or the right channel, in order to maintain a stereo form and hence maintain a width in a stereo field. Therefore, a process of extracting the instrumental signal from the audio comprises following steps. An instrumental is extracted from a left channel or a right channel, and the left-channel instrumental or the right-channel instrumental is determined to serve as the instrumental signal of the audio. Assuming that the audio has a left channel, i.e., dataLeft, and a right channel, i.e., dataRight, the left-channel instrumental may be extracted from dataLeft as the instrumental signal of the audio, or the right-channel instrumental may be extracted from dataRight as the instrumental signal of the audio.

A vocal-instrumental separating tool (such as the Spleeter) may be adopted for extracting the vocal signal and the instrumental signal from the audio. It is assumed that the two different versions of the same song are song1 and song2. After the vocal-instrumental separation, two vocal signals, i.e., vocal1 and vocal2, and two instrumental signals, i.e., surround1 and surround2, may be obtained.

In S203, tracks of all vocal signals in the vocal set are aligned based on reference rhythm information, where the reference rhythm information is selected from rhythm information of all vocal signals in the vocal set, and all vocal signals having the aligned tracks are determined to serve as to-be-mixed vocal audios.

The original version, the cover version, and the remix version of the same song may have different singing modes or languages, and hence there may be deviations among tracks of the vocal signals. Therefore, it is necessary to align the tracks of all vocal signals, so as to ensure good coordination and good synchronization among the vocal signals.

In S204, an instrumental signal, of which a track is aligned with the tracks of the to-be-mixed vocal audios, is determined from the instrumental set to serve as a to-be-mixed instrumental audio.

After all vocal signals are synchronized with each other, it is necessary to synchronize the to-be-mixed instrumental audio with the tracks of all vocal signals. It is assumed that three audios (audios A, B, and C) are subject to mixing. Three vocal signals, i.e., vocalA, vocalB, and vocalC, and three instrumental signals, i.e., surroundA, surroundB, and surroundC may be obtained. It is further assumed that that a track of vocalA is unchanged, and a track of vocalB and a track of vocalC are adjusted to be aligned with the track of vocalA. In such case, surroundA may be directly determined as the to-be-mixed instrumental audio. In a case that it is desirable to use surroundB or surroundC as the to-be-mixed instrumental audio, a track of surroundB or surroundC should be aligned with that of surround A in the same manner as aligning the vocal signals, so as to ensure complete alignment between the vocal and the instrumental.

In a specific embodiment, a process of determining the instrumental signal of which the track is aligned with the tracks of the to-be-mixed vocal audios from the instrumental set to serve as the to-be-mixed instrumental audio comprises a following step. An instrumental signal, of which a track is aligned with the reference rhythm information, is determined from the instrumental set to serve as the to-be-mixed instrumental audio. Or, a track of an instrumental signal in the instrumental set is aligned with the reference rhythm information, and the instrumental signal having the aligned track is determined to serve as the to-be-mixed instrumental audio.

In S205, the to-be-mixed vocal audios are mixed with the to-be-mixed instrumental audio to obtain a remix.

Generally, distribution of the vocal audio between the left channel and the right channel should be calculated before mixing the vocal audio with the instrumental audio. That is, the vocal signal should be allocated to the left channel and the right channel, and hence the left channel and the right channel receive sub-signals having different energy. Therefore, a process of mixing the vocal audios with the instrumental audio to obtain the remix comprises following steps. A left-channel gain and a right-channel gain are calculated. Stereo signals are determined for all vocal signals, respectively, in the vocal audios based on the left-channel gain and the right-channel gain. The stereo signals are mixed with the instrumental audio to obtain the remix. The tracks of the vocal signals in the vocal audios are synchronized. For each vocal signal, sub-signals allocated to the left channel and the right channel may be calculated based on the left-channel gain and the right-channel gain, and the sub-signals are called the stereo signal of such vocal signal.

Assuming that the left-channel gain is gainLeft and the right-channel gain is gainRight, the sub-signal of the vocal signal, i.e., vocalA, on the left channel is calculated as vocalALeft=vocalAxgainLeft, and the sub-signal of vocalA on the right channel is calculated as vocalARight=vocalAxgainRight. vocalALeft and vocalARight together form the stereo signal of vocalA.

A process of mixing the stereo signals with the instrumental audio to obtain the remix comprises a following step. The stereo signals are mixed with the instrumental audio based on a fourth equation to obtain the remix, where the fourth equation is SongComb=alphax(vocal1+ . . . +vocalN)+(1-alpha)×surround. SongComb represents the remix, vocal1, . . . , and vocalN represent the stereo signals, respectively, alpha represents a preset adjustment factor, and surround represents the instrumental audio. alpha ranges from 0 to 1. Adjusting alpha toward less than 0.5 indicates that a background (i.e., the instrumental) is enhanced in final mixing, and a surrounding effect and an immersive feeling of music is improved. Adjusting the alpha toward greater than 0.5 indicates that the vocal clearer in the final mixing, and an effect of clear vocal is imposed.

Low-frequency components of surround may be enhanced through software such as an equalizer before mixing the stereo signals with the instrumental audio, so as to render an overall rhythm of music more preeminent. Alternatively, each stereo signal is subject to pitch altering plus tempo maintaining before mixing the stereo signals with the instrumental audio, so as to obtain more modes of singing.

The left-channel gain and the right-channel gain may be calculated through either of the following manners.

In a first manner, the left-channel gain and right-channel gain are calculated based on a preset angle in a stereo field and an angle of the vocal signal in the stereo field. It is assumed that the preset angle is thetaBase and the angle of the vocal signal is theta. The gains are calculated as:

gain=[tan(thetaBase)−tan(theta)]/[tan(thetaBase)+tan(theta)].

The left-channel gain is calculated as gainLeft=gain/sqrt(gainxgain+1). The right-channel gain is calculated as gainRight=1/sqrt(gainxgain+1).

In a second manner, the left-channel gain and the right-channel gain are calculated by allocating linear gains. It is assumed that the vocal is positioned on left of a central position. There are gainLeft=1.0, and gainRight=1.0-pan. The parameter pan is a real number ranging from 0 to 1. In a case that pan is equal to 0, there are gainLeft=1.0 and GainRight=1.0, which indicates that the vocal is in the direct front. In a case that pan is equal to 1, there has gainLeft=1.0 and GainRight=0, which indicates that the vocal is on direct left. Accordingly, amplitude of pan may be adjusted to change an angle of the vocal in a range from the direct front to the direct left. The two gains need to be swapped for cases in which the vocal is a front-right region.

In the first manner, the stereo adjustment is performed through setting an adjustment angle. In the second manner, the stereo adjustment is performed through allocating linear gains. The vocal can be positioned to at any angle within the left 90-degree range and the right 90-degree range. Thereby, a controllable chorus effect can be achieved, and the stereo field can be more complete, such that a user can adjust the position of the sound image easily and conveniently without changing a spectrum of the vocal signal. Hence, vocals recorded at different times or positions can be mixed into a same song.

Appearance and disappearance of each vocal signal in the vocal audios may depend on time. For example, only one vocal signal or some vocal signals may appear during a certain period of time, achieving an antiphonal effect.

Herein the at least two singing versions of the same song can be mixed, and the solution is applicable to a variety of songs. During the mixing, the reference rhythm information is selected from the rhythm information of all audios. The tracks of all vocal signals of the singing versions are aligned based on the reference rhythm information, and the instrumental signal of which the track is aligned with the tracks of the vocal signals is determined. Therefore, coordination and synchronization in elements such as lyrics and beats can be achieved when mixing vocal and instrumental, and thereby the obtained remix has an improved mixing effect.

In the above embodiments, aligning the tracks of all vocal signals in the vocal set based on the reference rhythm information selected from the rhythm information of all audios may be implemented in various manners. Hereinafter one of the manners is illustrated. In an embodiment, the rhythm information is information concerning beats, and the alignment comprises following steps S301 to S313.

In S301, beat information is extracted from the audios to obtain a beat set comprising at least two pieces of beat information.

The beat information in each audio may be extracted through the Beattracker or a drum extraction algorithm.

Pieces of the beat information in the beat set are mapped to the vocal signals in the vocal set in one-to-one correspondence. For example, the audio mixing is performed on three audios A, B, and C, and hence three vocal signals vocalA, vocalB, and vocalC (which form the vocal set), three instrumental signals suroundA, suroundB, and suroundC (which form the instrumental set), and three pieces of beat information BeatA, BeatB, and BeatC (which form the beat set) are obtained. Elements in the above three sets are in one-to-one correspondence, namely, vocalA to surroundA to BeatA, vocalB to surround to BeatB, and vocalC to surround to BeatC.

In S302, it is determined whether a quantity of elements in each piece of beat information in the beat set is identical. The method proceeds to S303 in case of positive determination, and proceeds to S308 in case of negative determination.

Each piece of beat information in the beat set comprises multiple elements (i.e., beats or beat points). Different pieces of beat information comprising elements of the same quantity indicate that audios corresponding to the different beat information have similar rhythms and belong to the same song arrangement. In such case, the beats in the audios differ little from each other, and hence the method may proceed to steps S303 to S307 may be adopted for rough alignment. Different pieces of beat information comprising elements of different quantities indicate that audios corresponding to the different beat information have different rhythms and belong to different song arrangements. In such case, the beats in the audios differ significantly from each other. Hence, the audios need to be adjusted in a frame level, and the method should proceed to steps S309 to S313 for segmentation and finer alignment.

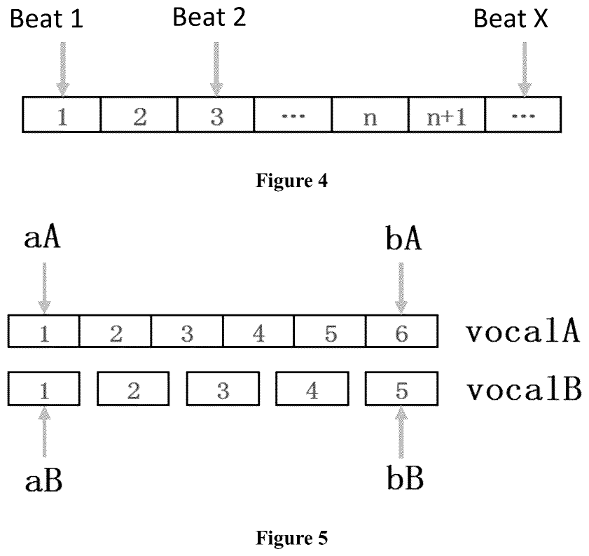

Reference may be made to FIG. 4 for the beats comprised in the beat information. In FIG. 4, “1”, “2”, “3”, . . . , “n”. “n+1”, . . . represent data frames in the audio of the song. Arrows indicate timestamp positions corresponding to the beats. The positions of these beats are also applicable to vocal signals.

In S303, a first piece of beat information is determined to serve as the reference rhythm information. The first piece of beat information may be an arbitrary piece of beat information in the beat set.

In S304, a difference between the first piece of beat information and each second piece of beat information is calculated.

The second piece(s) of beat information refers to piece(s) of beat information in the beat set other than the first beat piece of information. For example, BeatA in the foregoing beat set is the first piece beat information, and BeatB and BeatC in the beat set are the second pieces of beat information.

A process of calculating the difference between the first piece of beat information and the second piece of beat information comprises a following step. The difference between the first piece of beat information and the second piece of beat information are calculated based on a first equation, where the first equation is:

M=[sum(Beat0−BeatX)/numBeats]×L.

M represents the difference between Beat0 and BeatX. Beat0 represents a vector representation of the first piece of beat information, and BeatX represents a vector representation of the second piece of beat information. Sum(Beat0-BeatX) represents a cumulative sum of all differences obtained by subtracting BeatX from Beat0 element-wise (i.e., based on corresponding timestamps of each element). numBeats represents a quantity of elements in each piece of beat information (i.e. a quantity of elements comprised in any piece of beat information). L represents a length of a data frame which serves as a data unit.

For example, a difference between BeatA and BeatB is calculated as M=[sum (BeatA-BeatB)/numBeats]×L.

In S305, the difference is mapped to a second vocal signal to obtain first one-to-one correspondence.

The second vocal signal(s) refers to vocal signal(s) in the vocal set other than a first vocal signal, and the first vocal signal refers to a vocal signal in the vocal set and corresponding to (or mapped to) the first piece of beat information. In the above example, BeatA is determined as the first piece of beat information. Hence, the first vocal signal is vocalA, and the second vocal signals are vocalB and vocalC.

In S306, a redundant end and a to-be-compensated end of each second vocal signal are determined based on the corresponding difference, which is determined according to the first one-to-one correspondence, for adjusting said second vocal signal.

In S307, redundant data is removed from the redundant end and zero-value data are added at the to-be-compensated end for each second vocal signal, where the redundant data and the zero-value data each has a data length equal to the difference.

Through steps S303 to S307, the vocal signals are aligned by integral shifting, and such manner obeys a principle of minimizing the Euclidean distance. In the above example, M being positive indicates that singing in audio A starts later than singing in audio B, vocalB is shifted backward (to the right) by M data points with vocalA serving as the reference. The redundant end and the to-be-compensated end of vocalB are determined by using a start point and an ending point of vocalA as reference points. After the shifting, a portion of the vocalB exceeding vocalA is “cut off” at the redundant end, and a “missing” portion of vocalB at the to-be-compensated end in comparison with vocalA is compensated with zero values. Thereby, vocalB and vocalA are aligned with each other.

In S308, it is determined whether a quantity of the audios that are current obtained is only two. The method proceeds to S309 in case of positive determination, and terminates in case of negative determination.

In S309, a third piece of beat information is determined to serve as the reference rhythm information, where the third piece of beat information has a minimum quantity of elements among the beat set.

In S310, a quantity of elements in a fourth piece of beat information is reduced to be identical to a quantity of elements in the third piece of beat information.

The fourth piece of beat information refers to a piece of beat information in the beat set other than the third piece of beat information. It is assumed that the beat set comprises BeatA and BeatB, BeatA comprises three elements aA, bA, and cA, and BeatB comprises four elements aB, bB, cB, and dB. Hence, BeatA is determined to serve as the third piece of beat information, and BeatB is determined to serve as the fourth piece of beat information.

A process of reducing the quantity of elements in the fourth piece of beat information to be identical to the quantity of elements in the third piece of beat information comprises following steps. The elements in the third piece of beat information are sorted based on magnitude of timestamps to obtain a target sequence. A sequential number of a current iteration is determined, and an element of which a sequential number in the target sequence is equal to the sequential number of the current iteration is determined to serve as a target element. A distance between a timestamp of the target element and a timestamp of each comparison element is calculated, where the comparison element(s) refers to element(s) which are in the fourth piece of beat information and has not been matched with any element in the target sequence. A comparison element corresponding to a minimum of the distances is determined to match the target element. In a case that the sequential number of the current iteration is not less than a maximum quantity of iterations, the remaining comparison elements are deleted from the fourth piece of beat information, and the element matching each target element is retained in the fourth piece of beat information.

In a case that the sequential number of the current iteration is less than the maximum quantity of iterations, the sequential number of the current iteration is incremented by one. Again, the element of which the sequential number in the target sequence is equal to the sequential number of the current iteration is determined to serve as the target element, the distance between the timestamp of the target element and the timestamp of each comparison element is calculated, and the comparison element corresponding to the minimum of the distances is determined to match the target element. The foregoing operations iterate until the sequential number of the current iteration is not less than a maximum quantity of iterations. The maximum quantity of iterations is equal to the quantity of elements in the third piece of beat information.

In the above example, it is necessary to delete an element from BeatB. A specific process of the deletion is as follows. It is assumed that the elements in BeatA have been sorted in an ascending order of the timestamps, and the maximum quantity of iterations is 3.

In the first iteration, the sequential number of the current iteration count is 1, the target element is aA. The distance between the timestamps of aA and aB, the distance between timestamps of aA and bB, the distance between timestamps of aA and cB, and the distance between timestamps of aA and dB are calculated, and the four obtained distances are 0.1, 0.2, 0.3, and 0.4, respectively. The minimum distance is 0.1, which corresponds to the comparison element aB, and hence aA is determined to match aB. At such time, the sequential number of the current iteration is less than the maximum quantity of iterations, i.e., 3, and hence is increased from 1 to 2. In the second iteration, the target element is bA.

Since aA matches aB, aB is no longer a comparison element. Hence, a distance between timestamps of bA and bB, a distance between timestamps of bA and cB, and a distance between timestamps of bA and dB are calculated, and the three obtained distances are 0.5, 0.6, and 0.7. The minimum distance is 0.5, which corresponds to the comparison element bB, and hence bA is determined to match bB. At such time, the sequential number of the current iteration is less than the maximum quantity of iterations, i.e., 3, and hence is increased from 2 to 3. In the third iteration, the target element is cA. Since aA matches aB and bA matches bB, aB and bB are no longer comparison elements. Hence, a distance between timestamps of cA and cB and a distance between timestamps between cA of dB are calculated, and the obtained two distances are 0.7 and 0.8. The minimum distance is 0.7, which corresponds to the comparison element cB, and hence cA is determined to match cB. At such time, the sequential number of the current iteration not less than the maximum quantity of iterations, i.e., 3. Accordingly, the remaining comparison element dB is deleted from BeatB (since aA matches aB, bA matches bB, and cA matches cB, dB is the only comparison element left in BeatB), and aB, bB, and cB are retained. Thereby, BeatA and BeatB each has only 3 elements. BeatA comprises three elements aA, bA, and cA, and BeatB has three elements: aB, bB, and cB.

In S311, multiple groups of adjacent beats are determined based on the third piece of beat information or the fourth piece of beat information.

In the above case, BeatA comprises three elements aA, bA, and cA, and BeatB comprises three elements aB, bB, and cB. Two groups of adjacent beats may be determined, i.e., a+b, and b+c. A first data segment corresponding to a+b is a segment in vocalA between aA and bA, and a second data segment corresponding to a+b is a segment in vocalB between aB and bB. A first data segment corresponding to b+c is a segment in vocalA between bA and cA, and a second data segment corresponding to b+c is a segment in vocalB between bB and cB.

Reference is made to FIG. 5, which illustrates the group a+b of adjacent beats. The first data segment (in vocalA) corresponding to the group comprise 4 data frames (i.e., data frames 2, 3, 4, and 5), and the second data segment (in vocalB) corresponding to the group comprise 3 data frames (data frames 2, 3, and 4).

In S312, the third vocal signal and the fourth vocal signal is divided based on each group of adjacent beats to obtain a first data segment and a second data segment corresponding to such group of adjacent beats.

The third vocal signal is in the vocal set and mapped to the third piece of beat information. The fourth vocal signal(s) are vocal signal(s) in the vocal set other than the third vocal signal. In the case that BeatA serves as the third piece of beat information and BeatB serves as the fourth piece of beat information, the third vocal signal is vocalA and the fourth vocal signal is vocalB. The first data segment is a segment from the third vocal signal, and the second data segment is a segment from the fourth vocal signal.

In S313, a data length of the first data segment and a data length of the second data segment are adjusted to be equal for each group of adjacent beats.

A length of the data frame which serves as a data unit is fixed. Hence, a quantity of first data frames in the first data segment is equal to a quantity of second data frames in the second data segment, when the data length of the first data segment is equal to the data length of the second data segment.

As shown in FIG. 5, the quantity of first data frames in the first data segment is not equal to the quantity of second data frames in the second data segment, and hence the data segment corresponding to a maximum between the quantity of the first data frames and the quantity of the second data frames is determined to be an shortening target. A shortened length of each data frame in the shortening target is calculated, and each data frame in the shortening target is shortened based on the shortened length.

A process of calculating the shortened length of each data frame in the shortening target comprises a following step. The shortened length is calculated based on a second equation P=[(m−n)×L]/m. P represents the shortened length of each data frame, m represents the maximum between the quantity of first data frames and the quantity of second data frames, n represent a minimum of the quantity of first data frames and the quantity of second data frames, and L represents the length of the data frame serving as the data unit. As shown in FIG. 5, the maximum is 4 and the minimum is 3, and hence the shortened length of each data frame is calculated as P=[(4-3)×L]/4=L/4. A head or a tail is deleted from all data frames when shortening each data frame, and the remaining parts of the data frames are spliced according to their original sequence.

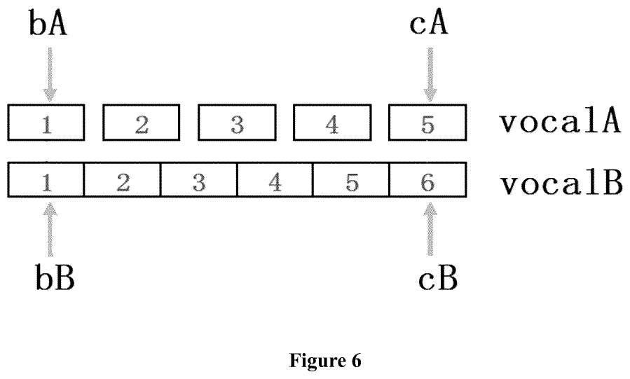

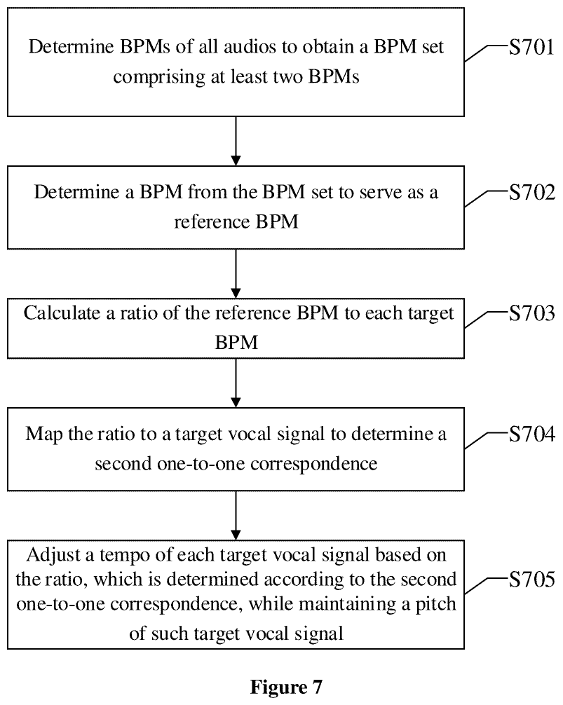

Reference is made to FIG. 6, which illustrates a group b+c of adjacent beats. The first data segment (in vocalA) corresponding to the group comprises 3 data frames (i.e., data frames 2, 3, and 4), and the second data segment (in vocalB) corresponding to the group comprises 4 data frames (i.e., data frames 2, 3, 4, and 5). Accordingly, when performing shortening for all groups of adjacent beats, sometimes vocalA should be shortened, while sometimes vocalB should be shortened. Steps S309 to S313 illustrates audio mixing on only two audios. Through steps S309 to S313, data segments in vocalA and data segments in vocalB are respectively aligned, so that vocalA and vocalB are aligned.

Three, four, or more vocal signals can be aligned based on similar logic throughout steps S309 to S313. It is assumed that there are three vocal signals, i.e., vocal1, vocal2 and vocal3, to be aligned. vocal1 and vocal2 may be aligned through steps S309 to S313 to obtain vocal1′ and vocal2′, respectively, which are in alignment with each other. vocal1′ and vocal2′ have a same quantity of data frames, and hence may be considered identical (with respect to the quantity of data frames). Then, vocal1′ and vocal3 are aligned, and vocal2′ and vocal3 are aligned. Thereby, the three vocal signals are in alignment with each other.

Since vocal1′ and vocal2′ is considered identical, data removed from vocal1′ and data removed from vocal2′ are consistent with each to other when aligning vocal1′ and vocal2′ respectively with vocal3. As to vocal3, the same part of data are removed when aligning vocal1′ and vocal2′ respectively with vocal3. That is, alignment between vocal1′ and vocal3 and alignment between vocal2′ and vocal3 would result in the same vocal3′. It is assumed that a final result of the alignment is vocal1″, vocal2″, and vocal3′ which are aligned with each other. It is appreciated that it is not necessary to align vocal2′ with vocal3 in a case of vocal1″=vocal1′, because there is vocal2″=vocal2′ in such case.

In a case that each vocal signal is altered during the alignment, the corresponding instrumental signals needs to be aligned in a same manner as the vocal signals, such that the finally outputted instrumental signals are in alignment with the aligned vocal signals.

In the foregoing embodiments, tracks of vocals of different versions are aligned with each other based on the beat information of the audios. Herein at least two singing versions of the same song can be mixed, and the solution for audio mixing is applicable to a variety of songs. During the mixing, the reference rhythm information is selected from the rhythm information of all audios. The tracks of all vocal signals of the singing versions are aligned based on the reference rhythm information, and the instrumental signal of which the track is aligned with the tracks of the vocal signals is determined. Therefore, coordination and synchronization in elements such as lyrics and beats can be achieved when mixing vocal and instrumental, and thereby the obtained remix has an improved mixing effect.

In embodiments of the present disclosure, a process of aligning the tracks of all vocal signals in the vocal set based on the reference rhythm information which is determined from the rhythm information of all audios may be implemented in various manners.

Hereinafter one of the manners is illustrated. In an embodiment, the rhythm information is beats per minute (BPM), a manner of the alignment comprises following steps S701 to S705.

In S701, BPMs of all audios determined to obtain a BPM set comprising at least two BPMs.

The BPM of the audio may be determined through a BPM detection algorithm.

The BPM is short for beats per minute, also called beat counts, which represents a quantity of beats per minute. The BPMs in the BPM set are in one-to-one correspondence with the vocal signals in the vocal set. For example, the audio mixing is performed on three audios A, B, and C, and hence, three vocal signals vocalA, vocalB, and vocalC (which form the vocal set) and three BPMs BPMA, BPMB, and BPMC (which form the BPM set) are obtained. Accordingly, elements in the vocal set are in the one-to-one correspondence to elements in the BPM set, namely, vocalA to BPMA, vocalB to BPMB, and vocalC to BPMC.

In S702, a BPM is determined from the BPM set to serve as a reference BPM.

The reference BPM is the reference rhythm information. The BPM may be randomly selected from the BPM set to serve the reference BPM.

In S703, a ratio of the reference BPM to each target BPM is calculated.

The target BPM(s) is BPM(s) in the BPM set other than the reference BPM. It is assumed BPMA is determined from the BPM set to serve as the reference BPM. In such case, BPMB and BPMC each is the target BPM, and the ratios may be calculated as BPMA/BPMB and BPMA/BPMC.

In S704, the ratio is mapped to a target vocal signal to determine a second one-to-one correspondence.

The target vocal signal(s) are vocal signal(s) in the vocal set other than a reference vocal signal, and the reference vocal signal refers to a vocal signal in the vocal set and corresponding to (or mapped to) the reference BPM. In the above example, BPMA is determined to serve as the reference BPM, hence the reference vocal signal is vocalA, and the target vocal signals comprise vocalB and vocalC.

In S705, a tempo of each target vocal signal is adjusted based on the ratio, which is determined according to the second one-to-one correspondence, while maintaining a pitch of such target vocal signal.

In the above example, BPMA/BPMB corresponds to vocalB, and BPMA/BPMC corresponds to vocalC. Therefore, a tempo of vocalB is adjusted based on BPMA/BPMB without altering a pitch of vocalB, and a tempo of vocalC is adjusted based on BPMA/BPMC without altering a pitch vocalC. Thereby, vocalA, vocalB, and vocalC can be aligned with each other. Herein the adjustment may be implemented via a processor for tempo altering plus pitch maintaining.

In the foregoing embodiments, tracks of vocals of different versions are aligned with each other based on the beat information of the audios. Herein at least two singing versions of the same song can be mixed, and the solution for audio mixing is applicable to a variety of songs. During the mixing, the reference rhythm information is selected from the rhythm information of all audios. The tracks of all vocal signals of the singing versions are aligned based on the reference rhythm information, and the instrumental signal of which the track is aligned with the tracks of the vocal signals is determined. Therefore, coordination and synchronization in elements such as lyrics and beats can be achieved when mixing vocal and instrumental, and thereby the obtained remix has an improved mixing effect.

On a basis of the foregoing embodiments, loudness of the vocal signals having the aligned tracks may be balanced based on root mean squares (RMSs) of different vocal signals before they are determined to serve as the to-be-mixed vocal audios, so as to prevent a difference in loudness from reducing an effect of the audio mixing. In an embodiment, a process of balancing loudness of the vocal signals comprises following steps. A vocal signal is determined from the vocal signals having the aligned tracks to serve as a standard vocal signal. Loudness of each to-be-adjusted vocal signal is adjusted based on a third equation, where said to-be-adjusted vocal signal is among the vocal signals having the aligned tracks aligned and other than the standard vocal signal. The third equation is:

B=vocalX×(RMSO/RMSX).

B represents the to-be-adjusted vocal signal after the loudness is adjusted, vocalX represents the to-be-adjusted vocal signal before the loudness is adjusted, RMSO represents a root mean square of the standard vocal signal, and RMSX represents a root mean square of vocalX.

It is assumed that the vocal signals having the aligned tracks are vocalA, vocalB, and vocalC and correspond to RMSA, RMSB, and RMSC, respectively, and vocalA is determined to serve as the standard vocal signal that is randomly selected. In such case, vocalB is adjusted to be vocalBx(RMSA/RMSB), and vocalC is adjusted to be vocalC×(RMSA/RMSC). Thereby, a difference in loudness among vocalA, vocalB, and vocalC is reduced.

It is appreciated that alternatively or additionally, two vocal signals may be inputted into a left channel and a right channel, respectively, for test listening, and it is determined through human hearing whether the two tracks have similar loudness. In case of negative determination, the loudness of the vocal signals is adjusted until the two vocal signals are judged to have similar loudness.

Herein the difference among loudness of the vocal signals is reduced through a principle that left and right ears are capable to recognize energy difference. Thereby, a stereo vocal mixing can be achieved.

Hereinafter a specific application scenario is described to illustrate a solution for generating a remix according to an embodiment of the present disclosure. The solution is capable of generating a remix based on existing songs. A tool for generating a remix may be developed based on the solution, and the remix can be generated through the tool. The tool may be installed on a computer device. The tool is configured to implement the method for generating the remix according to embodiments of the present disclosure.

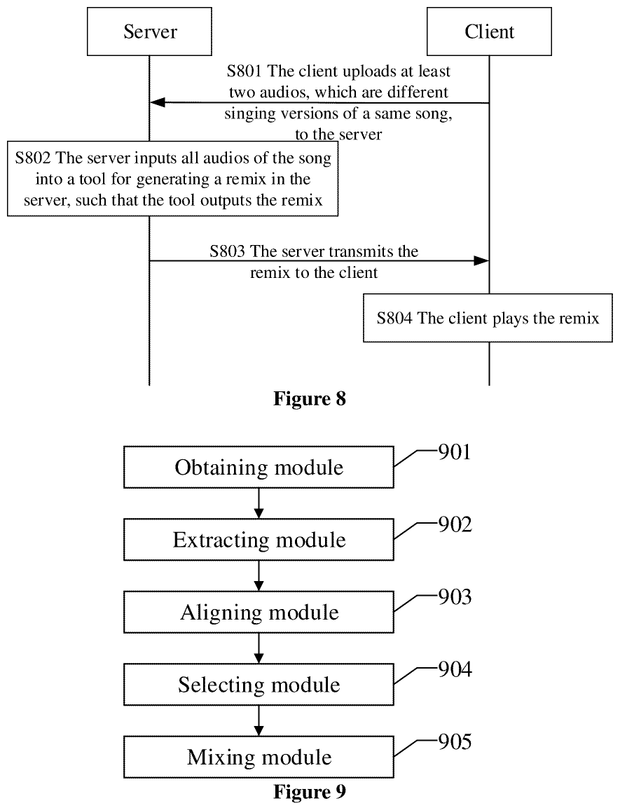

Reference is made to FIG. 8. A process of generating a remix may comprise following steps S801 to S804.

In S801, a client uploads at least two audios, which are different singing versions of a same song, to the server.

In S802, a server inputs all audios of the song into a tool for generating a remix in the server, such that the tool outputs the remix.

In S803, the server transmits the remix to the client.

In S804, the client plays the remix.

Herein the tool for generating the remix is applicable to all songs in a music library. A user may upload any song for audio mixing based on his/her desire. In a case that the library comprises only one singing version of the song, the user may sing the vocal part along with the separated instrumental, such that his/her own singing and the profession singer's singing can be mixed in the remix. Moreover, different singing versions for the audio mixing are only required to have the same melody, while the vocals are even allowed to be in different languages.

Herein the vocals are aligned with each other based on the beats or the BPMs of the audios, and a ratio of the vocal to the background can be altered to render the vocal or the background more preeminent, such that a wider range can be covered in the stereo field. A pitch of the vocal can be adjusted, and a ratio among frequency components in the background can be adjusted. In addition, an angle in the stereo field and temporal appearance of the vocal, a ratio of the vocal to the background, the pitch of the vocal, and energy of each frequency component in the background can be arbitrarily adjusted to obtain remixes having different styles and different singing effects. Thereby, secondary production of music becomes easier.

Herein the tool for generating the remix enables a user to alter the vocal (create a dual-vocal effect at various angles, or alter a pitch of the vocal only) or alter the background (enhance the vocal, increase width in the stereo field, enhance the rhythm, or the like). Such generation scheme expands a range of songs covered by the dual-vocal effect significantly, and enriches content and modes for audio mixing.

Reference is made to FIG. 9, which is a schematic diagram of an apparatus for generating a remix according to an embodiment of the present disclosure. The apparatus includes an obtaining module 901, an extracting module 902, an aligning module 903, a selecting module 904 and a mixing module 905.

The obtaining module 901 is configured to obtain at least two audios which are different singing versions of a same song.

The extracting module 902 is configured to extract, from each of the at least two audios, a vocal signal and an instrumental signal to obtain a vocal set and an instrumental set, where the vocal set comprises the vocal signal of each of the at least two audios, and the instrumental set comprises the instrumental signal of each of the at least two audios.

The aligning module 903 is configured to align tracks of all vocal signals in the vocal set through referring to reference rhythm information, where the reference rhythm information is selected from rhythm information of all vocal signals in the vocal set, and all vocal signals having the aligned tracks serve as to-be-mixed vocal audios.

The selecting module 904 is configured to determine an instrumental signal, of which a track is aligned with the tracks of the to-be-mixed vocal audios, from the instrumental set as a to-be-mixed instrumental audio.

The mixing module 905 is configured to mix the to-be-mixed vocal audios with the to-be-mixed instrumental audio to obtain the remix.

In an embodiment, the extracting module comprises a first extracting unit or a second extracting unit.

The first extracting unit is configured to: for each of the at least two audios, calculate a median signal of said audio, and extract the vocal signal from the median signal.

The second extracting unit is configured to: for each of the at least two audios, extract vocals from a left channel and a right channel, respectively, of said audio, and average the vocals in amplitude or spectral features to obtain the vocal signal.

In an embodiment, the extracting module comprises a third extracting unit. The third extracting unit is configured to: for each of the at least two audios, extract an instrumental from a left channel or a right channel of said audio, and determine the instrumental as the instrumental signal.

In an embodiment, the rhythm information is beat information, and the aligning module comprises a beat extracting unit, a first selecting unit, a first calculating unit, a first determining unit, a second determining unit, and a first aligning unit.

The beat extracting unit is configured to: extract a piece of beat information from each of the at least two audios to obtain a beat set, where the beat set comprises the piece of beat information of each of the at least two audios, and the piece of beat information and the vocal signal are mapped to each other for each of the at least two audio to obtain one-to-one correspondence.

The first selecting unit is configured to determine a first piece of beat information in the beat set as the reference rhythm information, in response to a quantity of elements in each piece of beat information being identical throughout the beat set.

The first calculating unit is configured to, for each of one or more second pieces of beat information, calculate a difference between the first piece of beat information and said second piece of beat information, where the one or more second pieces of beat information are in the beat set and other than the first piece of beat information.

The first determining unit is configured to, for each of the one or more second pieces of beat information, map the difference to a respective one of one or more second vocal signals based on the one-to-one correspondence to obtain first correspondence, where the one or more second vocal signals are in the vocal set and other than a first vocal signal, and the first vocal signal is in the vocal set and mapped to the first piece of beat information.

The second determining unit is configured to, for each of the one or more second vocal signals, determine a redundant end and a to-be-compensated end based on the corresponding difference, which is determined according to the first correspondence, for adjusting said second vocal signal.

The first aligning unit is configured to, for each of the one or more second vocal signals, remove redundant data from the redundant end and add zero-value data at the to-be-compensated end, where the redundant data and the zero-value data each has a data length equal to the difference.

In an embodiment, the first calculating unit is configured to: calculate the difference between the first piece of beat information and said second pieces of beat information based on M=[sum(Beat0-BeatX)/numBeats]×L, where M is the difference, Beat0 is a vector representation of the first piece of beat information, BeatX is a vector representation of said second piece of beat information, sum(Beat0-BeatX) represents calculating a sum of all elements in a vector obtained by subtracting BeatX from Beat0, numBeats is a quantity of elements in each piece of beat information, and L represents a length of a data frame serving as a data unit.

In an embodiment, the aligning module further comprises a second selecting unit, a shortening unit, a third determining unit, a dividing unit, and a second aligning unit.

The second selecting unit is configured to determine a third piece of beat information as the reference rhythm information, where the third piece of beat information has minimum elements among the beat set, in response to a quantity of the at least two audios being two and the quantity of elements in each piece of beat information being different in the beat set.

The shortening unit is configured to reduce the quantity of elements in a fourth piece of beat information to be identical to the quantity of elements in the third piece of beat information, where the fourth piece of beat information is in the beat set and other than the third piece of beat information.

The third determining unit is configured to determine groups of adjacent beats based on the third piece of beat information or the fourth piece of beat information.

The dividing unit is configured to divide the third vocal signal and the fourth vocal signal based on each of the groups of adjacent beats to obtain a first data segment and a second data segment corresponding to said group of adjacent beats, where the third vocal signal is in the vocal set and mapped to the third piece of beat information, and the fourth vocal signal is in the vocal set and other than the third vocal signal.

The second aligning unit is configured to adjust, for each of the groups of adjacent beats, a data length of the first data segment and a data length of the second data segment to be equal.

In an embodiment, the second aligning unit comprises a first determining subunit and a first calculating subunit.

The first determining subunit is configured to determine a data segment having most data frames among the first data segment and the second data segment as an shortening target, in response to the quantity of data frames in the first data segment being not equal to the quantity of data frames in the second data segment.

The first calculating subunit is configured to calculate a shortened length for each data frame in the shortening target, and shortening each data frame in the shortening target based on the shortened length.

In an embodiment, the calculating subunit is configured to: calculate the shortened length based on P=[(m−n)×L]/m, where P is the shortened length, m is a maximum between the quantity of data frames in the first data segment and the quantity of data frames in the second data segment, n represent a minimum between the quantity of data frames in the first data segment and the quantity of data frames in the second data segment, and L is a length of a data frame serving as the data unit.

In an embodiment, the shortening unit comprises a sorting subunit, a second determining subunit, a second calculating subunit, a third determining subunit, and a deleting subunit.

The sorting subunit is configured to sort elements in the third piece of beat information based on magnitude of timestamps to obtain a target sequence.

The second determining subunit is configured to determine a sequential number of a current iteration, and determine an element, of which a sequential number in the target sequence is equal to the sequential number of the current iteration, in the third piece of beat information as a target element.

The second calculating subunit is configured to calculate a distance between a timestamp of the target element and a timestamp of each of one or more comparison elements, where each of the one or more comparison elements is in the fourth piece of beat information and has not been matched to any element in the target sequence.

The third determining subunit is configured to determine a comparison element corresponding to the minimum distance among the one or more comparison elements to match the target element.

The deleting subunit is configured to delete, from the fourth piece of beat information, the one or more comparison elements that remain, and retain, in the fourth piece of beat information, the one or more comparison elements that have been matched to any element in the target sequence, in response to the sequential number of the current iteration being not less than a maximum quantity of iterations.

In an embodiment, the shortening unit further comprises an iterating subunit. The iterating subunit is configured to increase the sequential number of the current iteration by one and trigger the second determining subunit, the second calculating subunit, and the third determining subunit to operate, in response to the sequential number of the current iteration being less than the maximum quantity of iterations.

In an embodiment, the rhythm information is BPM, and the aligning module comprises a collecting unit, a third selecting unit, a second calculating unit, a fourth determining unit and a third aligning unit.

The collecting unit is configured to determine the BPM of each of the at least two audios to obtain a BPM set, where the BPM set comprises the BPM of each of the at least two audios, and the BPM in the BPM set is mapped to the vocal signal in the vocal set for each of the at least two audios to obtain one-to-one correspondence.

The third selecting unit is configured to determine a BPM from the BPM set as a reference BPM, where the reference BPM serves as the reference rhythm information.

The second calculating unit is configured to calculate a ratio of the reference BPM to each of one or more target BPMs, where the one or more target BPMs are in the BPM set and other than the reference BPM.

The fourth determining unit is configured to, for each of the one or more target BPMs, map the ratio to a respective one of one or more target vocal signals based on the one-to-one correspondence to obtain second correspondence, where the one or more target vocal signals are in the vocal set other than a reference vocal signal, and the reference vocal signal is in the vocal set is mapped to the reference BPM.

The third aligning unit is configured to, for each of the one or more target vocal signals, alter a tempo of said target vocal signal based on the ratio, which is determined according to the second correspondence, while maintaining a pitch of said target vocal signal.

In an embodiment, the method further comprises a standard-vocal selecting module and an adjusting module.

The standard-vocal selecting module is configured to determine a vocal signal from the vocal signals having the aligned tracks as a standard vocal signal.

The adjusting module is configured to adjust loudness of each of one or more to-be-adjusted vocal signals based on B=vocalX×(RMSO/RMSX), where the one or more to-be adjusted vocal signals are among the vocal signals having the tracks aligned and other than the standard vocal signal, B is said to-be-adjusted vocal signal after the loudness is adjusted, vocalX is said to-be-adjusted vocal signal before the loudness is adjusted, RMSO is a root mean square of the standard vocal signal, and RMSX is a root mean square of vocalX.

In an embodiment, the mixing module comprises a third calculating unit, a fifth determining unit, and a mixing unit.

The third calculating unit is configured to calculate a gain for a left channel and a gain for a right channel.

The fifth determining unit is configured to determine a stereo signal of each vocal signals in the to-be-mixed vocal audios based on the gain for the left channel and the gain for the right channel.

The mixing unit is configured to mix the stereo signal of each vocal signal in the to-be-mixed vocal audios with the instrumental audio to obtain the remix.

In an embodiment, the mixing unit is configured to mix the stereo signal of each vocal signal in the to-be-mixed vocal audios with the instrumental audio based on

SongComb=alphax(vocal1+ . . . +vocalN)+(1−alpha)×surround,

to obtain the remix, where SongComb is the remix, vocal1, . . . , vocalN each is the stereo signal, alpha is a preset adjustment factor, and surround is the instrumental audio.

In an embodiment, the third calculating unit is configured to calculate the gain for the left channel and the gain for the right channel based on a preset angle in a stereo field and an angle of the vocal signal in the stereo field, or calculate the gain for the left channel and the gain for the right channel by allocating linear gains.

In an embodiment, the selecting module comprises a fourth selecting unit or a fourth aligning unit.

The fourth selecting unit is configured to determine an instrumental signal, of which the track is aligned with the reference rhythm information, from the instrumental set as the to-be-mixed instrumental audio.

The fourth aligning unit is configured to align a track of an instrumental signal in the instrumental set with the reference rhythm information, and determine the instrumental signal having the aligned track as the to-be-mixed instrumental audio.

Detailed operations of the modules and the units as mentioned above may refer to what is disclosed in the previous embodiments, and are not repeated herein.

Herein the apparatus for generating the remix is provided. The tracks of the vocals of the different versions are aligned with each other based on the beat information of the audios. The at least two singing versions of the same song can be mixed, and the mixing is applicable to a variety of songs. During the mixing, the tracks of all vocal signals in the singing versions are aligned, and the instrumental signal aligned with the to-be-mixed vocal signals in tracks is selected. Therefore, coordination and synchronization in elements such as lyrics and beats can be achieved when mixing vocal and instrumental, and thereby the obtained remix has an improved mixing effect.

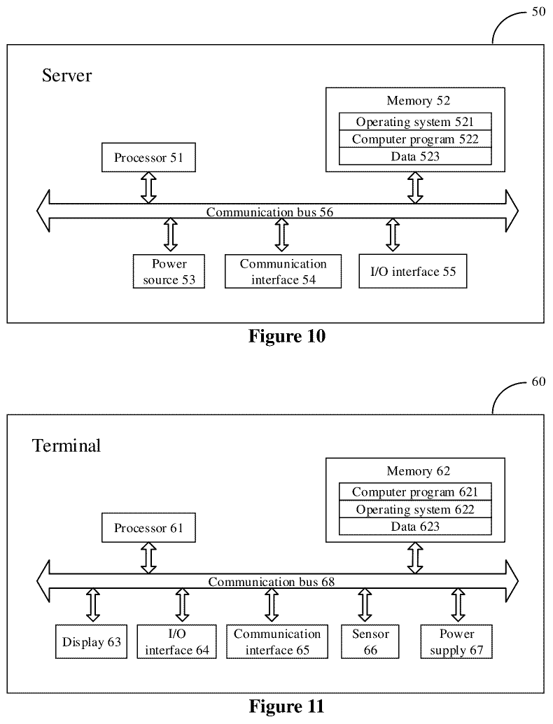

An electronic device is further provided according to an embodiment of the present disclosure. The electronic device may be either a server 50 as shown in FIG. 10 or a terminal 60 as shown in FIG. 11. Each of FIG. 10 and FIG. 11 is a structural diagram of an electronic device according to an exemplary embodiment. Content in the figures should not be considered as any limitation on a scope of the present disclosure.

FIG. 10 is a schematic structural diagram of a server according to an embodiment of the present disclosure. The server 50 may comprise at least one processor 51, at least one memory 52, a power supply 53, a communication interface 54, an input/output interface 55 and a communication bus 56. The memory 52 stores a computer program. The computer program is loaded and executed by the processor 51 to implement the method for generating the remix provided according to any foregoing embodiment.

In this embodiment, the power supply 53 is configured to provide an operating voltage for hardware components of the server 50. The communication interface 54 is capable of creating a data transmission channel between the server 50 and an external device. The communication interface 54 complies with a communication protocol applicable to the technical solution of the present disclosure, which is not specifically limited herein. The input/output interface 55 is configured to acquire data inputted from or outputted to outside. A type of the input/output interface 55 may be selected based on an actual requirement, which is not specifically limited herein.

In addition, the memory 52 serves as a carrier for resource storage, and may be a read-only memory, a random access memory, a magnetic disk, an optical disk, or the like. Resources stored on the memory may include an operating system 521, a computer program 522, audio signal data 523, and the like, which may be temporarily stored or permanently stored.

The operating system 521 is configured to manage and control hardware devices and computer programs 522 on the server 50, such that the processor 51 can implement calculation and processing on the data 523 in the memory 52. The operating system 521 may be Windows Server, Netware, Unix, Linux, or the like. Besides a computer program for implementing the method according to any foregoing embodiments, the computer program 522 may further include a computer program for executing other specific tasks. The data 523 may include audio data o for mixing, and may further include data such as information of an application provider.

FIG. 11 is a schematic structural diagram of a terminal according to an embodiment of the present disclosure. The terminal 60 may include, but is not limited to, smartphones, tablets, laptops, or desktop computers.

Generally, the terminal 60 comprises a processor 61 and a memory 62.

The processor 61 may comprise one or more processing cores, such as a 4-core processor, an 8-core processor, or the like. The processor 61 may adopt at least one hardware form among the DSP (digital signal processing), the FPGA (field programmable gate array), and the PLA (programmable logic array). The processor 61 may further include a main processor and a coprocessor. The main processor is a processor for processing data in a wake-up state, also called a CPU (central processing unit). The coprocessor is a low-power processor for processing data in a standby state. In some embodiments, the processor 61 may be integrated with a GPU (graphics processing unit), and the GPU is configured to render and draw content to be displayed on a display screen. In some embodiments, the processor 61 may further include an AI (artificial intelligence) processor, and the AI processor is configured to process computing operations related to machine learning.

The memory 62 may comprise one or more computer-readable storage media, and may be non-transitory. The memory 62 may include a high-speed random access memory and a non-volatile memory, such as one or more magnetic disk storage apparatuses and one or more flash memory storage apparatuses. Herein the memory 62 is at least configured to store a computer program 621 as follows. The computer program after being loaded and executed by the processor 61 can implement relevant steps, in the method according to any forgoing embodiment, which are performed by the first terminal or the second terminal. In addition, resources stored in the memory 62 may further store an operating system 622, data 623, and the like. Such storage may be temporary storage or permanent storage. The operating system 622 may include the Windows, the Unix, the Linux, and the like. The data 623 may include, but is not limited to, audios to be mixed.

In some embodiments, the electronic device 60 may further comprise a display 63, an input/output interface 64, a communication interface 65, a sensor 66, a power supply 67 and a communication bus 68.

Those skilled in the art can understand that the structure as shown in FIG. 11 does not constitute a limitation on the terminal 60 and may include more or fewer components than those as shown in FIG. 11.

A storage medium is further provided according to an embodiment of the present disclosure. The storage medium stores computer-executable instructions. The computer-executable instructions, when loaded and executed by a processor, implement the method according to any foregoing embodiment. Specific steps of the method may refer to content disclosed in the foregoing embodiments, and are not repeated herein.

It should be noted that the above are only preferable embodiments of the present disclosure and are not intended to limit the present disclosure. Any modification, equivalent replacement, improvements, and the like, made within the spirit and principle of the present disclosure shall fall within the protection scope of the present disclosure.

The embodiments of the present disclosure are described in a progressive manner, and each embodiment places emphasis on the difference from other embodiments. Therefore, one embodiment can refer to other embodiments for the same or similar parts. Since apparatuses disclosed in the embodiments correspond to methods disclosed in the embodiments, the description of the apparatuses is simple, and reference may be made to the relevant part of the methods.

Herein specific examples are utilized to explain the principle and implementation of the present disclosure. The above examples are only used to help understand the methods and core ideas of this application. Meanwhile, those skilled in the art may make t changes in specific implementations and application scenarios based on concepts of the present disclosure. In summary, content of the specification should not be construed as a limitation on the present disclosure.

1. A method for generating a remix, comprising:
obtaining at least two audios which are different singing versions of a same song;
extracting, from each of the at least two audios, a vocal signal and an instrumental signal to obtain a vocal set and an instrumental set, wherein the vocal set comprises the vocal signal of each of the at least two audios, and the instrumental set comprises the instrumental signal of each of the at least two audios;
aligning tracks of all vocal signals in the vocal set through referring to reference rhythm information, wherein the reference rhythm information is selected from rhythm information of all vocal signals in the vocal set, and all vocal signals having the aligned tracks serve as to-be-mixed vocal audios;
determining an instrumental signal, of which a track is aligned with the tracks of the to-be-mixed vocal audios, from the instrumental set as a to-be-mixed instrumental audio; and
mixing the to-be-mixed vocal audios with the to-be-mixed instrumental audio to obtain the remix.

2. The method according to claim 1, wherein extracting the vocal signal from each of the at least two audios comprises: for each of the at least two audios,
calculating a median signal of said audio, and extract the vocal signal from the median signal, or
extracting vocals from a left channel and a right channel, respectively, of said audio, and average the vocals in amplitude or spectral features to obtain the vocal signal.

3. The method according to claim 1, wherein extracting the instrumental signal from each of the at least two audios comprises: for each of the at least two audios,
extracting an instrumental from a left channel or a right channel of said audio, and
determining the instrumental as the instrumental signal.

4. The method according to claim 1, wherein the rhythm information is beat information, and aligning the tracks of all vocal signals in the vocal set through referring to the reference rhythm information comprises:
extracting a piece of beat information from each of the at least two audios to obtain a beat set, wherein the beat set comprises the piece of beat information of each of the at least two audios, and the piece of beat information and the vocal signal are mapped to each other for each of the at least two audio to obtain one-to-one correspondence; and
in response to a quantity of elements in each piece of beat information being identical throughout the beat set,
determining a first piece of beat information in the beat set as the reference rhythm information,
for each of one or more second pieces of beat information,
calculating a difference between the first piece of beat information and said second piece of beat information, wherein the one or more second pieces of beat information are in the beat set and other than the first piece of beat information; and
mapping the difference to a respective one of one or more second vocal signals based on the one-to-one correspondence to obtain first correspondence, wherein the one or more second vocal signals are in the vocal set and other than a first vocal signal, and the first vocal signal is in the vocal set and mapped to the first piece of beat information; and
for each of the one or more second vocal signals,
determining a redundant end and a to-be-compensated end based on the corresponding difference, which is determined according to the first correspondence, for adjusting said second vocal signal; and
removing redundant data from the redundant end and adding zero-value data at the to-be-compensated end, wherein the redundant data and the zero-value data each has a data length equal to the difference.

5. The method according to claim 4, wherein calculating the difference between the first piece of beat information and said second piece of beat information comprises:
calculating the difference between the first piece of beat information and said second piece of beat information based on M=[sum(Beat0−BeatX)/numBeats]×L, wherein:
M is the difference, Beat0 is a vector representation of the first piece of beat information, BeatX is a vector representation of said second piece of beat information, sum (Beat0−BeatX) represents calculating a sum of all elements in a vector obtained by subtracting BeatX from Beat0, numBeats is a quantity of elements in each piece of beat information, and L represents a length of a data frame serving as a data unit.

6. The method according to claim 4, further comprising: in response to a quantity of the at least two audios being two and the quantity of elements in each piece of beat information being different in the beat set,
determining a third piece of beat information as the reference rhythm information, wherein the third piece of beat information has minimum elements among the beat set;
reducing the quantity of elements in a fourth piece of beat information to be identical to the quantity of elements in the third piece of beat information, wherein the fourth piece of beat information is in the beat set and other than the third piece of beat information;
determining groups of adjacent beats based on the third piece of beat information or the fourth piece of beat information after the reducing; and
for each of the groups of adjacent beats,
dividing the third vocal signal and the fourth vocal signal based on said group of adjacent beats to obtain a first data segment and a second data segment corresponding to said group of adjacent beats, wherein the third vocal signal is in the vocal set and mapped to the third piece of beat information, and the fourth vocal signal is in the vocal set and other than the third vocal signal; and
adjusting a data length of the first data segment and a data length of the second data segment to be equal.

7. The method according to claim 6, wherein adjusting the data length of the first data segment and the data length of the second data segment to be equal comprises: in response to the quantity of data frames in the first data segment being not equal to the quantity of data frames in the second data segment,
determining a data segment having most data frames among the first data segment and the second data segment as an shortening target;
calculating a shortened length for each data frame in the shortening target; and
shortening each data frame in the shortening target based on the shortened length.

8. The method according to claim 7, wherein the calculating the shortened length for each data frame in the shortening target comprises:
calculating the shortened length based on P=[(m−n)×L]/m, wherein:
P is the shortened length, m is a maximum between the quantity of data frames in the first data segment and the quantity of data frames in the second data segment, n represent a minimum between the quantity of data frames in the first data segment and the quantity of data frames in the second data segment, and L is a length of a data frame serving as the data unit.

9. The method according to claim 6, wherein reducing the quantity of elements in the fourth piece of beat information to be identical to the quantity of elements in the third piece of beat information comprises:
sorting elements in the third piece of beat information based on magnitude of timestamps to obtain a target sequence;
determining a sequential number of a current iteration;
determining an element, of which a sequential number in the target sequence is equal to the sequential number of the current iteration, in the third piece of beat information as a target element;
calculating a distance between a timestamp of the target element and a timestamp of each of one or more comparison elements, wherein each of the one or more comparison elements is in the fourth piece of beat information and has not been matched to any element in the target sequence;
determining a comparison element corresponding to the minimum distance among the one or more comparison elements to match the target element; and
in response to the sequential number of the current iteration being not less than a maximum quantity of iterations,
deleting, from the fourth piece of beat information, the one or more comparison elements that remain, and
retaining, in the fourth piece of beat information, the one or more comparison elements that have been matched to any element in the target sequence.

10. The method according to claim 9, further comprising: in response to the sequential number of the current iteration being less than the maximum quantity of iterations,
repeating:
updating the sequential number of the current iteration by an increment of one; and
determining the element, of which the sequential number in the target sequence is equal to the updated sequential number of the current iteration, in the third piece of beat information as a new target element;
calculating the distance between the timestamp of the new target element and the timestamp of each of the one or more comparison elements;
determining the comparison element corresponding to the minimum distance among the one or more comparison elements to match the target element;
until the sequential number of the current iteration is less than the maximum quantity of iterations.

11. The method according to claim 1, wherein the rhythm information is a beats per minute (BPM), and aligning the tracks of all vocal signals in the vocal set through referring to the reference rhythm information comprises:
determine the BPM of each of the at least two audios to obtain a BPM set, wherein the BPM set comprises the BPM of each of the at least two audios, and the BPM in the BPM set is mapped to the vocal signal in the vocal set for each of the at least two audios to obtain one-to-one correspondence;
determining a BPM from the BPM set as a reference BPM, wherein the reference BPM serves as the reference rhythm information;
calculating a ratio of the reference BPM to each of one or more target BPMs, wherein the one or more target BPMs are in the BPM set and other than the reference BPM;
for each of the one or more target BPMs, mapping the ratio to a respective one of one or more target vocal signals based on the one-to-one correspondence to obtain second correspondence, wherein the one or more target vocal signals are in the vocal set other than a reference vocal signal, and the reference vocal signal is in the vocal set is mapped to the reference BPM; and
for each of the one or more target vocal signals, altering a tempo of said target vocal signal based on the ratio, which is determined according to the second correspondence, while maintaining a pitch of said target vocal signal.

12. The method according to claim 1, before all vocal signals having the aligned tracks are determined to serve as the to-be-mixed vocal audios, the method further comprises:
determining a vocal signal from the vocal signals having the aligned tracks as a standard vocal signal; and
adjusting loudness of each of one or more to-be-adjusted vocal signals based on B=vocalX×(RMSO/RMSX), wherein:
the one or more to-be adjusted vocal signals are among the vocal signals having the tracks aligned and other than the standard vocal signal;
B is said to-be-adjusted vocal signal after the adjusting, vocalX is said to-be-adjusted vocal signal before the adjusting, RMSO is a root mean square of the standard vocal signal, and RMSX is a root mean square of vocalX.

13. The method according to claim 1, wherein mixing the to-be-mixed vocal audios with the to-be-mixed instrumental audio to obtain the remix comprises:
calculating a gain for a left channel and a gain for a right channel;
determining a stereo signal of each vocal signals in the to-be-mixed vocal audios based on the gain for the left channel and the gain for the right channel; and
mixing the stereo signal of each vocal signal in the to-be-mixed vocal audios with the instrumental audio to obtain the remix.

14. The method according to claim 13, wherein mixing the stereo signal of each vocal signal in the to-be-mixed vocal audios with the instrumental audio to obtain the remix comprises:
mix the stereo signal of each vocal signal in the to-be-mixed vocal audios with the instrumental audio based on SongComb=alphax(vocal1+ . . . +vocalN)+(1−alpha)×surround, to obtain the remix, wherein:
SongComb is the remix, vocal1 to vocalN each is the stereo signal, alpha is a preset adjustment factor, and surround is the instrumental audio.

15. The method according to claim 13, wherein calculating the gain for the left channel and the gain for the right channel comprises:
calculating the gain for the left channel and the gain for the right channel based on a preset angle in a stereo field and an angle of the vocal signal in the stereo field, or
calculating the gain for the left channel and the gain for the right channel by allocating linear gains.

16. The method according to claim 1, wherein determining the instrumental signal, of which the track is aligned with the tracks of the to-be-mixed vocal audios, from the instrumental set as the to-be-mixed instrumental audio comprises:
determining an instrumental signal, of which the track is aligned with the reference rhythm information, from the instrumental set as the to-be-mixed instrumental audio, or
aligning a track of an instrumental signal in the instrumental set with the reference rhythm information, and determining instrumental signal having the aligned track as the to-be-mixed instrumental audio.

17. (canceled)

18. An apparatus for generating a remix, comprising
a processor; and
a memory storing a computer program,
wherein the computer program when loaded and executed by the processor performs:
obtaining at least two audios which are different singing versions of a same song:
extracting, from each of the at least two audios, a vocal signal and an instrumental signal to obtain a vocal set and an instrumental set, wherein the vocal set comprises the vocal signal of each of the at least two audios, and the instrumental set comprises the instrumental signal of each of the at least two audios:
aligning tracks of all vocal signals in the vocal set through referring to reference rhythm information, wherein the reference rhythm information is selected from rhythm information of all vocal signals in the vocal set, and all vocal signals having the aligned tracks serve as to-be-mixed vocal audios:
determining an instrumental signal, of which a track is aligned with the tracks of the to-be-mixed vocal audios, from the instrumental set as a to-be-mixed instrumental audio; and
mixing the to-be-mixed vocal audios with the to-be-mixed instrumental audio to obtain the remix.

19. A storage medium, storing computer-executable instructions, wherein:
the computer-executable instructions when loaded and executed by a processor performs:
obtaining at least two audios which are different singing versions of a same song:
extracting, from each of the at least two audios, a vocal signal and an instrumental signal to obtain a vocal set and an instrumental set, wherein the vocal set comprises the vocal signal of each of the at least two audios, and the instrumental set comprises the instrumental signal of each of the at least two audios:
aligning tracks of all vocal signals in the vocal set through referring to reference rhythm information, wherein the reference rhythm information is selected from rhythm information of all vocal signals in the vocal set, and all vocal signals having the aligned tracks serve as to-be-mixed vocal audios:
determining an instrumental signal, of which a track is aligned with the tracks of the to-be-mixed vocal audios, from the instrumental set as a to-be-mixed instrumental audio; and
mixing the to-be-mixed vocal audios with the to-be-mixed instrumental audio to obtain the remix.
